(19) United States
(12) Patent Application Publication
(10) Pub. No.: US 2002/0126516 A1
(43) Pub. Date: Sep. 12, 2002

(54) Double control apparatus capable of saving power and power control method thereof

(76) Inventor: Cheol-Min Jeon, Gumi-city (KR)

Correspondence Address: Robert E. Bushnell, Suite 300, 1522 K Street, N.W., Washington, DC, 20005-1202, US

(21) Appl. No.: 09/843,778

(22) Filed: Apr. 30, 2001

(30) Foreign Application Priority Data
Jan. 10, 2001 (KR) 2001-1348

(51) Int. Cl. H02M 1/00

(52) U.S. Cl. 363/67

(57) ABSTRACT

A double control apparatus capable of saving power and a power control method thereof are provided. The double control apparatus has a first power supply unit for converting alternating current (AC) power input from the outside into direct current (DC) power, and providing the DC power as the first power; a function performing unit, which is driven in response to a second power, for performing predetermined function(s); an external interface unit, which is driven in response to the first power and the second power, for receiving control information from the outside and outputting input state information to the outside; an auxiliary control unit, which is driven in response to the first power, for receiving the control information from the external interface unit, outputting the state information to the external interface unit, and in response to a sleep mode signal, outputting a power control signal; a main control unit, which is driven in response to the second power, for outputting the state information, which is obtained by executing a program for controlling the function performing unit, to the auxiliary control unit in response to the control information input from the auxiliary control unit, and generating the sleep mode signal in response to the result of checking whether or not performing the predetermined function by the function performing unit is completed; and a second power supply unit for outputting the first power as the second power in response to the power control signal. Therefore, power can be saved in the sleep mode.

### CLAIM OF PRIORITY

This application makes reference to, incorporates the same herein, and claims all benefits accruing under 35 U.S.C § 119 from an application entitled Double Control Unit Capable Of Saving Power And Power Control Method Thereof earlier filed in the Korean Industrial Property Office on Jan. 10, 2001, and there duly assigned Serial No. 2001-1348 by that Office.

### BACKGROUND OF THE INVENTION

1. Field of the Invention

The present invention relates to a double control apparatus having a main control unit and an auxiliary control unit, and more particularly, to a double control apparatus capable of saving power, which can save power in a sleep mode, and a power control method performed in the double control apparatus capable saving power.

2. Description of the Related Art

At present in the U.S., a movement for preventing pollution by reducing energy consumption in the residential section, that is, Energy Star Residential Program, is being expanded. The goal of this program is to spread high-efficiency energy apparatuses up to 100% of households by the year 2010. As a step for this program, the Environmental Protection Agency (EPA) of the U.S. grants an Energy Star® label to a product complying with a predetermined standard.

Office equipment, led by computers, is the fastest growing electric load in the business world. In fact, office equipment accounts for about 7 percent of all commercial sector electricity usage, but much of this energy is wasted. That is because many people leave their computers, printers, facsimile machines, etc., on even when they are not in use during the business day, and some are even left on overnight and on weekends. The Version 2.0 of the MOU (Memorandum of Understanding) Energy Star® low power guidelines for printers, facsimile machines and Printer/Fax combination machines that took effect Oct. 1, 1995 were set as shown in the following table:

TABLE 1

| | | Printer | |
|---|---|---|---|
| Pages per Minute | Average Watts in | Default Time | |
| (1) | Low Power Mode | (2) | Fax Default Time |
| 0<ppm<7 | 15 W | 15 minutes | 5 minutes |
| 7<ppm<14 | 30 W | 30 minutes | 5 minutes |
| >14 ppm and color | 45 W | 60 minutes | 15 minutes |
| high end | | | |

(1) Based on rated print engine speed

(2) Default time=minimum period of time before printer or fax machine automatically enters sleep mode. Printer/Fax combination products may be set at the printer default time.

Printers, for example, are typically left on 24 hours a day but are active only a small percent of the time. This means that conventional printers can waste a lot of energy and money. Energy Star® labeled printers automatically power down to 15 to 45 watts, depending on the number of pages produced per minute. The automatic power down feature could cut a printer's electricity use by over 65 percent. Accordingly, maximization of energy efficiency in electronic products under development is appearing as a very critical issue.

Hereinafter, an apparatus, which has a main control unit and an auxiliary control unit, for performing an intrinsic function is referred to as ‘a double control apparatus’. This double control apparatus has a function unit for performing the intrinsic function(s), and two control units, the main control unit and the auxiliary control unit, for performing their own functions and interfacing with the outside. For example, the main control unit controls the function unit for performing intrinsic function(s), and the auxiliary control unit, under the main control unit's control, controls an interface unit for interfacing the double control apparatus with the outside. Therefore, by virtue of the main control unit and auxiliary control unit, the double control can perform its own functions, without being affected by an external interrupt, that is, even when information is input by an external user. For example, the double control apparatus can be a multifunctional peripheral (MFP) printer, which performs printer functions together with copying, faxing, and scanning functions.

New regulations issued by the EPA, such as Energy Star® limitations, impose stricter power save mode power consumption levels for printers and other image forming devices. Conventional printers and other imaging forming devices will have great difficulty in meeting these new limits as well as stricter limits in the future due to the above inefficiencies. Therefore, there exists a need to provide devices and methodologies providing increased efficiencies.

According to the above-described Energy Start® program, the EPA now plans to enforce from Nov. 1, 2001, a standard, which requires an MFP printer to change its mode into a sleep mode in which the printer consumes 15 watts or less within 30 minutes or 5 watts or less within 60 minutes, wherein the MFP printer is capable of printing papers between 7 sheets and 15 sheets per minute.

However, the conventional MFP printer supplies power, for example, +5 volts, which is provided through a switching mode power supply (SMPS), to the main control unit, auxiliary control unit and function unit at the same time, and enters into the sleep mode by the main control unit. Therefore, even when the holding current of a motor in the conventional MFP printer is set to 0 mA in a sleep mode, the conventional MFP printer needs about 2-watt power consumption of the SMPS and about 7-watt power consumption of the main control unit and auxiliary control unit and therefore, cannot comply with the EPA standard, which requires 5-watt or less power consumption in a sleep mode.

### SUMMARY OF THE INVENTION

To solve the above problems, it is an object of the present invention to provide a double control apparatus capable of saving power in a sleep mode by an auxiliary control unit controlling power used in a main control unit and a function performing unit for performing predetermined functions.

It is another object to provide a power control method performed in the double control apparatus capable of saving power.

To accomplish the above object of the present invention, there is provided a double control apparatus, capable of saving power, having a first power supply unit for converting alternating current (AC) power input from the outside into direct current (DC) power, and providing the DC power as a first power; a function performing unit, which is driven in response to a second power, for performing predetermined function(s); an external interface unit, which is driven in response to the first power and the second power, for receiving control information from the outside and outputting input state information to the outside; an auxiliary control unit, which is driven in response to the first power, for receiving the control information from the external interface unit, outputting the state information to the external interface unit, and in response to a sleep mode signal, outputting a power control signal; a main control unit, which is driven in response to the second power, for outputting the state information, which is obtained by executing a program for controlling the function performing unit, to the auxiliary control unit in response to the control information input from the auxiliary control unit, and generating the sleep mode signal in response to the result of checking whether or not performing the predetermined function by the function performing unit is completed; and a second power supply unit for outputting the first power as the second power in response to the power control signal.

To accomplish another object of the present invention, there is also provided a power control method performed by the double control apparatus, the method having the steps of (a) generating a first power by converting an AC power into a DC power, and operating an auxiliary control unit by the generated first power; (b) generating a second power and operating a function performing unit and a main control unit by the generated second power; (c) continuously determining whether or not a sleep mode signal is generated when a predetermined time period (default time) elapses after a predetermined function is performed; (d) transmitting state information from the main control unit to the auxiliary control unit if the sleep mode signal is generated; and (e) cutting off the generation of the second power.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a double control apparatus capable of saving power according to the present invention; and

FIG. 2 is a flowchart for explaining a power control method, according to the present invention, which is performed in the double control apparatus shown in FIG. 1.

### DETAILED DESCRIPTION OF THE INVENTION

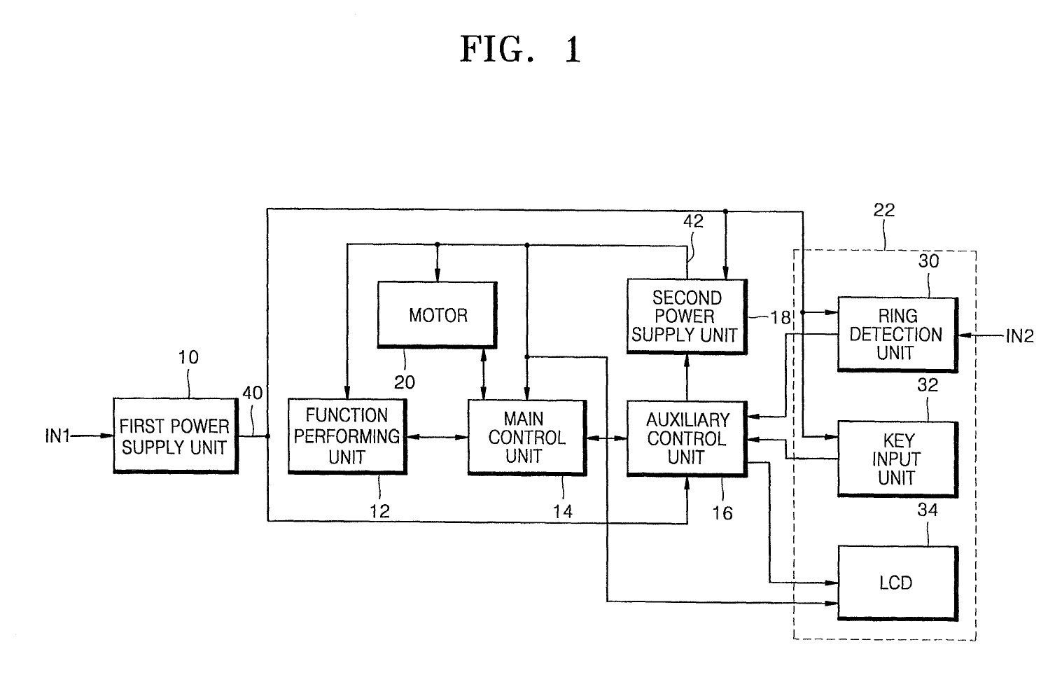

FIG. 1 is a block diagram of a double control apparatus capable of saving power according to the present invention, and the double control apparatus has a first power supply unit 10, a second power supply unit 18, a function performing unit 12, a main control unit 14, an auxiliary control unit 16, and an external interface unit 22.

A preferable embodiment of a double control apparatus capable of saving power, of the present invention, shown in FIG. 1, additionally has a motor 20, and the external interface unit 22 has a ring detection unit 30, a key input unit 32, and a liquid crystal display (LCD) 34, which will be explained later in detail.

The first power supply unit 10 converts alternating current (AC) power, which is externally input through an input terminal IN1, into direct current (DC) power, and provides the converted DC power, as the first power 40, to the auxiliary control unit 16, the second power supply unit 18 and corresponding units 30 and 32 of the external interface unit 22. For this, the first power supply unit 10 can be implemented by a switching mode power supply, and converts the primary AC power into DC power 40, such as +5, +12, or +30 volts.

The function performing unit 12 is driven in response to a second DC power 42 provided from the second power supply unit 18, and performs predetermined functions. According to an application of the present invention, the double control apparatus shown in FIG. 1 can be applied to a printer. In this case, the function performing unit 12 performs a printing function as a predetermined function.

According to another application of the present invention, the double control apparatus shown in FIG. 1 can be applied to an ink-jet or laser MFP printer. In this case, the function performing unit 12 performs additional other functions, for example, a fax function, a scanning function, and/or a copying function, as well as a printing function, as predetermined functions. To perform these applications, the function performing unit 12 can have a memory (not shown), a modem (not shown), and an image processor (not shown).

Also, to perform a printing function, the double control apparatus capable of saving power shown in FIG. 1 can additionally have a motor 20, which is driven in response to the second DC power 42 provided from the second power supply unit 18, and which operates by control of the main control unit 14.

Meanwhile, the main control unit 14 is driven in response to the second DC power 42 provided from the second power supply unit 18, and controls the function performing unit 12, the motor 20 and the auxiliary control unit 16 according to a program which can be stored in a program memory (not shown).

For example, the main control unit 14 outputs to the external interface unit 22 through the auxiliary control unit 16, state information obtained by executing a program for controlling the function performing unit 12 in response to control information input from the external interface unit 22 through the auxiliary control unit 16. Also, the main control unit 14 checks whether the function performing unit 12 finishes performing a predetermined function or still performs the predetermined function, generates a sleep mode signal in response to the result of checking, and outputs the generated sleep mode signal to the auxiliary control unit 16.

For this, the main control unit 14 can internally have a counter (not shown), which counts a predetermined time period when the function performing unit 12 finishes performing the predetermined function, and which generates a sleep mode signal if the predetermined time period is counted. For example, the predetermined time period can be 5, 15, 30 or 60 minutes. When generating the sleep mode signal, the main control unit 14 outputs state information, which indicates the state of the double control apparatus, to the auxiliary control unit 16.

26The auxiliary control unit 16 is driven in response to the first power 40 provided from the first power supply unit 10, and outputs control information input from the external interface unit 22 to the main control unit 14. Also, the auxiliary control unit 16 outputs a power control signal to the second power supply unit 18 in response to the sleep mode signal generated by the main control unit

When the main control unit 14 generates a sleep mode signal, the auxiliary control unit 16 controls the second power supply unit 18 by generating a power control signal so that the supply of the second power 42 is cut off. At this time, when the sleep mode signal is received from the main control unit 14, the auxiliary control unit 16 receives the state information output from the main control unit 14, and outputs the received state information to the external interface unit 22.

The main control unit 14 and the auxiliary control unit 16 described above use different clock signals and for this, each unit can have an oscillation circuit for generating its own clock signal.

Meanwhile, in response to the power control signal output from the auxiliary control unit 16, the second power supply unit 18 outputs the first DC power 40 provided from the first power supply unit 10 to the function performing unit 12, the main control unit 14, and the LCD 34, as the second DC power 42. For this, the second power supply unit 18 can be implemented by a power transistor (not shown). In this case, in response to a power control signal generated by the auxiliary control unit 16 when a sleep mode signal is generated, the power transistor (not shown) of the second power supply unit 18 turns off so as not to generate the second DC power 42, and in response to a power control signal generated by the auxiliary control unit 16 when a sleep mode signal is not generated the power transistor (not shown) turns on so as to generate the second DC power 42.

Meanwhile, the external interface unit 22 is driven in response to the first DC power 40 provided from the first power supply unit 10 and the second DC power 42 provided from the second power supply unit 18. First, the external interface unit 22 has an LCD 34 which is driven in response to the second DC power 42 so that state information input from the main control unit 14 through the auxiliary control unit 16 can be displayed to an external user. Also, the external interface unit 22 has a key input unit 32 for receiving externally input control information and for outputting control information to the main control unit 14 through the auxiliary control unit 16. The key input unit 32 is driven in response to the first DC power 40, has a plurality of keys, and outputs, as a result of the user's manipulation of the keys, control information to the main control unit 14 through the auxiliary control unit 16.

Meanwhile, according to a preferable embodiment of the present invention, the auxiliary control unit 16 can generate the power control signal for turning on the second power supply unit 18 to generate the second DC power 42 in response to the control information input through the external interface unit 22, as described above, after the supply of the second DC power 42 from the second power supply unit 18 is cut off.

Additionally, the external interface unit 22 has a ring detection unit 30, which is driven in response to the first DC power 40, detects a ring signal received through the input terminal IN2 from. for example, a public switched telephone network (PSTN: not shown), and outputs the detected ring signal to the auxiliary control unit 16 as the control information. Therefore, during the sleep mode in which the supply of the second DC power 42 is cut off in response to the power control signal generated in response to the sleep mode signal, if control information from the ring detection unit 30 is input to the auxiliary control unit 16, the auxiliary control unit 16 controls the second power supply unit 18 by generating a power control signal so that the second power supply unit 18 is turned on and the second DC power 42 is regenerated.

A power control method performed in the double control apparatus capable of saving power according to the present invention, shown in FIG. 1, will now be further explained. At this time, a state in which the second DC power 42 is not generated in response to the generated sleep mode signal is defined as ‘a sleep mode’. Also, a state in which the function performing unit 12 continues to perform the predetermined function, the predetermined period does not elapse yet though performing the predetermined function is completed, or the second DC power 42 is regenerated by new control information input from the external interface unit 22 after the second power 42 is cut off, is defined as ‘an idle mode’.

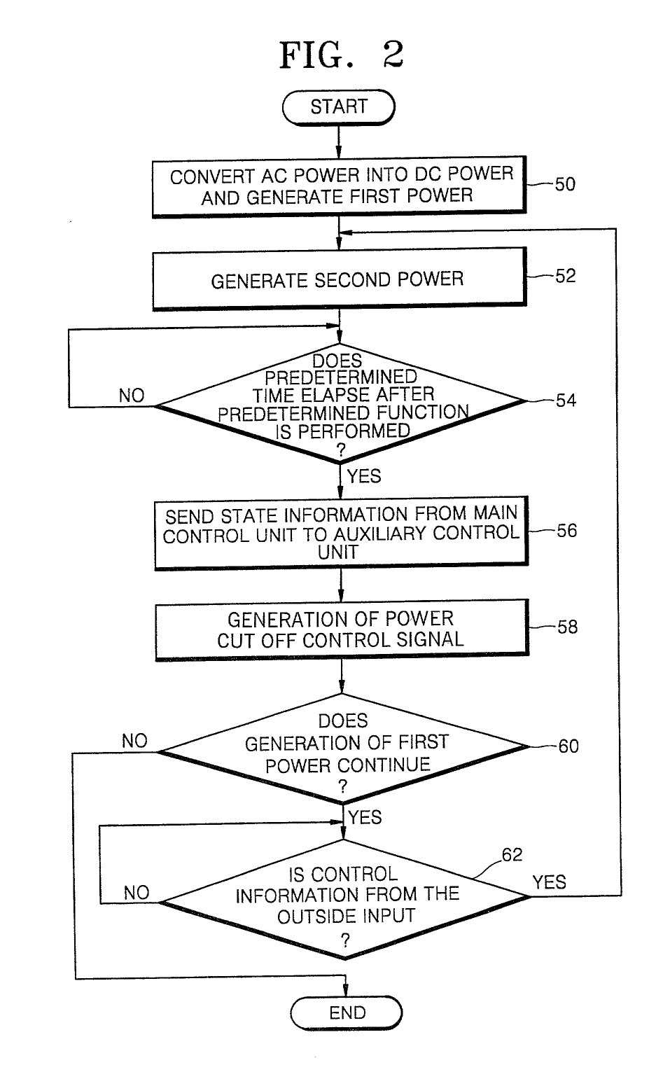

FIG. 2 is a flowchart for explaining a power control method, according to the present invention, which is performed in the apparatus shown in FIG. 1, and the power control method includes steps 50 and 52 for generating the first power 40 and the second power 42, and the steps 54 through 58 for cutting off the generation of the second power 42 according to whether the sleep mode signal is generated or not.

A preferable embodiment according to the present invention of the power control method shown in FIG. 2 additionally includes steps 60 and 62 for regenerating the second power 42 according to the control information input from the outside during a sleep mode when the first power 40 is continuously generated. This will be explained later.

In the power control method, according to the present invention, performed in the double control apparatus shown in FIG. 1, first, the auxiliary control unit 16, the ring detection unit 30, and the key input unit 32 are driven by the first power 40 obtained by converting AC power input through the input terminal IN1 in the first power supply unit 10 into DC power in step 50.

After the step 50, the second power 42 is generated, in step 52, in an idle mode in response to the power control signal generated by the auxiliary control unit 16, thus the second power supply unit 18 drives the function performing unit 12, the main control unit 14, the motor 20, and the LCD 34.

Following step 52, the main control unit 14 continuously determines, in step 54, whether or not a predetermined time period elapses after performing a predetermined function is completed by function performing unit 12. For this, the main control unit 14 counts the predetermined time period using the embedded counter (not shown) after the function performing unit 12 performs the as predetermined function and generates the sleep mode signal when the predetermined time period elapses.

When the predetermined time period elapses after performing the predetermined function is completed and the sleep mode signal is generated, the main control unit 14 transmits, in step 56, the generated sleep mode signal to the auxiliary control unit 16 as state information indicating that the generation of the sleep mode signal has occurred.

In response to the state information indicating that the generation of the sleep mode signal has occurred, the auxiliary control unit 16 outputs, in step 58, a power control signal for cutting off second power supply unit 18 to stop the generation of the second power 42. Accordingly, the double control apparatus shown in FIG. 1 enters into the sleep mode.

According to a preferable embodiment of the present invention, after the step 58, the auxiliary control unit 16 determines whether or not the first power 40 is continuously generated from the first power supply unit 10, in step 60. If the first power 40 is not continuously generated, the auxiliary control unit stops its operation, and all operations of the double control apparatus shown in FIG. 1 stop.

When it is determined in step 60 that the first power 40 is continuously generated, the auxiliary control unit 16 continuously determines, in step 62, whether or not control information is externally input via the external interface unit 22 until the externally input control information is detected. That is, if control information is input from external interface unit 22 during the sleep mode, the auxiliary control unit 16 outputs a control power signal to turn on the second power control unit 18 so that the second power supply unit 18 outputs the second power 42.

According to the above description, when in the sleep mode, power consumption of first power supply unit 10 is 2 Watts or less, of auxiliary control unit 16 is 0.5 Watts or less, of ring detection unit 30 is 0.1 Watts or less and of key input unit 32 is 0.5 Watts or less.

As described above, the double control apparatus capable of saving power and the power control method according to the present invention can meet the stricter Energy Star® requirement of the 5-watt or less power consumption in the sleep mode, when applied to an SMPS-type ink-jet printer or laser MFP printer, and can reduce costs because the apparatus uses the auxiliary control unit in the double control unit to control power so that separate devices for power control according to the present invention be not needed.

What is claimed is:

1. A double control apparatus, capable of saving power, comprising:
a first power supply unit for converting an externally input alternating current (AC) power into a direct current (DC) power, and providing the DC power as a first power;
a function performing unit, which is driven in response to a second power, for performing one or more predetermined functions;
an external interface unit, which is driven in response to the first power and the second power, for receiving control information from the outside and outputting input state information to the outside;
an auxiliary control unit, which is driven in response to the first power, for receiving the control information from the external interface unit, outputting the state information to the external interface unit, and outputting a power control signal in response to a sleep mode signal;
a main control unit, which is driven in response to the second power, for generating the state information, which is obtained by executing a program for controlling the function performing unit, for output to the auxiliary control unit in response to the control information input from the auxiliary control unit, and generating the sleep mode signal in response to the result of checking whether or not a predetermined time period has elapsed after the function performing unit finishes performing the predetermined function; and
a second power supply unit for outputting the first power as the second power in response to the power control signal.

2. The double control apparatus of claim 1, wherein the auxiliary control unit generates the power control signal in response to whether or not control information is input from the external interface unit.

3. The double control apparatus of claim 2, wherein the external interface unit comprises a ring detection unit, which is driven in response to the first power, for detecting a ring signal received through a public switched telephone network, and outputting the detected ring signal as the control information.

4. The double control apparatus of claim 2, wherein the external interface unit comprises a key input unit, which is driven in response to the first power and has a plurality of keys, and outputs the result of user's manipulation of keys as the control information.

5. The double control apparatus of claim 2, wherein the external interface unit comprises a liquid crystal display (LCD), which is driven in response to the second power, and displays the state information to the user.

6. The double control apparatus of claim 1, further comprising:
a motor which is driven in response to the second power and operates under control of the main control unit, wherein the predetermined function includes a printing function.

7. The double control apparatus of claim 6, wherein the predetermined functions further includes a facsimile function.

8. The double control apparatus of claim 7, wherein the predetermined functions further includes a scanning function.

9. The double control apparatus of claim 8, wherein the predetermined functions further includes a copying function.

10. A power control method performed by a double control apparatus, the method comprising the steps of:
generating a first power by converting an alternating current (AC) power into a direct current (DC) power;
operating an auxiliary control unit by the generated first power;
generating a second power;
operating a function performing unit and a main control unit by the generated second power;
continuously determining whether or not a predetermined time period elapses after a predetermined function is performed by the function performing unit;
generating a sleep mode signal when it is determined the predetermined time period has elapsed;
transmitting the sleep mode signal as state information from the main control unit to the auxiliary control unit;
generating a power cut off signal in response to the state information indicative of the sleep mode signal;
cutting off the generation of the second power in response to the power cut off signal; and
entering a sleep mode when the generation of the second power is cut off.

11. The power control method of claim 10, the method further comprising the steps of:
determining whether or not the first power is continuously generated during said sleep mode;
continuously determining, during said sleep mode, whether or not control information is input from an external interface unit, which is driven in response to the first power, when it is determined that the first power is continuously generated; and
returning the step of generating the second power when it is determined that the control information is input from the external interface unit.

12. The power control method of claim 11, the step of continuously determining, during said sleep mode, whether or not control information is input from an external interface unit further comprises:
monitoring a ring detection unit for input of a ring signal from a telephone network;
monitoring a key input unit for activation, by a user, of keys of said key input unit; and
generating said control information when said ring detection unit receives the ring signal or when said keys of said key input unit are activated.
